(19) United States
(12) Patent Application Publication
(10) Pub. No.: US 2006/0159442 A1
(43) Pub. Date: Jul. 20, 2006

(54) Method, medium, and apparatus with category-based clustering using photographic region templates

(75) Inventors: Sangkyun Kim, Youngin-si (KR); Jiyeun Kim, Seoul (KR); Youngsu Moon, Seoul (KR); Yongman Ro, Daejoon-si (KR); Seungil Yang, Wonju-Si (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRONICS CO., LTD., Suwon-si (KR); RESEARCH & INDUSTRIAL COOPERATION GROUP, Daejon-si (KR)

(21) Appl. No.: 11/332,283

(22) Filed: Jan. 17, 2006

(30) Foreign Application Priority Data
Jan. 14, 2005 (KR) 10-2005-0003913
Jan. 11, 2006 (KR) 10-2006-0002983

(51) Int. Cl. G03B 7/00

(52) U.S. Cl. 396/236

(57) ABSTRACT

A clustering method, medium, and apparatus using region division templates. According to the method, medium, and apparatus, in order to more reliably extract semantic concepts included in a photo, multiple content-based feature values can be extracted from region images divided by using region division templates, and the confidence degree of an input image in relation to the local semantic concept, defined by using the feature values, is measured. With respect to the confidence degree, the local semantic concepts of the photo can be merged and a more reliable local semantic concept can be extracted. By using the merged local semantic concept, the confidence degree of a global semantic concept is measured, and according to the confidence, multiple category concepts included in the input photo are extracted. By doing so, photo data can be quickly and effectively used to generate an album.

### CROSS-REFERENCE TO RELATED APPLICATIONS

This application claims the priority benefit of Korean Patent Application Nos. 10-2005-0003913, filed on Jan. 14, 2005 and 10-2006-0002983, filed on Jan. 11, 2006 in the Korean Intellectual Property Office, the disclosures of which are incorporated herein in their entirety by reference.

### BACKGROUND OF THE INVENTION

1. Field of the Invention

Embodiments of the present invention, as discussed herein, relate to a digital photo album, and more particularly, to a category-based photo clustering method, medium, and apparatus using region division templates.

2. Description of the Related Art

An ordinary digital photo album may be used to transfer photos from a digital camera or a memory card, for example, to a local storage apparatus of a user and may further be used to manage the photos in a computer, also as an example. Generally, by using such a photo album, users may want to index or arrange many photos according to a particular time series or according to photo categories arbitrarily designated by the users. The photos may thereafter be browsed according to the index, or photos may be shared with other users, for example.

In such a process, automatically clustering photos based on categories relative to the respective photos is one of the major desired operations of photo albums. Such a categorization reduces the necessary range of searching when retrieving a particular photo desired by a user. With this operation, the accuracy of the searching, as well as the searching speed, can be improved. Furthermore, by automatically classifying photos into categories desired by the user, management by the user of a large number of photos, e.g., in a single album, is made to be easier and more convenient.

However, most of the conventional categorization methods are text based, using meta data as specified, one by one, in text input by a user. However, the text-based method is not useful in that if the number of photos is large, it becomes almost impossible for a user to specify all category information of the photos one by one, and text information becomes ineffective in describing the underlying semantic concepts, i.e., identifiable features within the photo, of respective photos. Accordingly, a method of categorizing multimedia contents, by using content-based features in photos, such as colors, shapes, and texture, extracted based on the contents of respective photos, is desired.

To date, there has been extensive research into clustering photos by using content-based feature for photo images. However, as there may be a variety of semantic concepts within each photo, of potentially many photos, automatic extraction of multiple semantic concepts has been found to be still very difficult. As a means to solve this problem, one conventional approach includes extracting major objects in a photo (image) and, according to the semantic concepts of the objects, indexing or categorizing multiple photos. However, since extracting a variety of semantic concepts included in a photo is very difficult, conventionally, only major semantic concepts included in the photo have been extracted.

Among such conventional approaches, research has been focused primarily on extracting “main subjects” among semantic objects included in a photo and identifying and indexing these main objects, such as in the method for automatic determination of main subjects in photographic images performed by Eastman Kodak Company. That is, in the categorizing of photos, research has focused on the segmentation of objects included in a photo and the indexing or categorizing of the segmented object.

However, as described above, in most cases a large number of semantic concepts may be included in a single photo image, such that such a conventional approach of categorization by extraction of main subjects results in the loss of the other semantic concepts.

Generally, a photo can be divided at least into a foreground and a background. In categorization of photo data, a semantic concept included in the foreground is important, but the semantic concept included in the background is also important. The conventional approaches do not take this into account.

Accordingly, there is a need for a method of categorizing photo data, a method of extracting a variety of semantic concepts included in a photo by considering both concepts of the foreground and the background of the photo, rather than the conventional method of segmenting objects.

Thus, there is a need for a method of extracting a variety of semantic concepts from a photo, e.g., with a method of dividing an image into smaller regions and extracting at least a semantic concept from each divided region. Division of an image into smaller regions has the advantage of extraction ease in extracting a single semantic concept. However, if the area of the divided image is too small, it may become difficult to extract even a single semantic concept. That is, it is not easy to determine the size by which an image should to be divided. Accordingly, there is also a need for an effective method of dividing an image to extract a variety of semantic concepts of a photo and a method of extracting an accurate semantic concept from the divided image.

### SUMMARY OF THE INVENTION

Embodiments of the present invention include at least a category-based clustering method, medium, and system and a digital photo album, method, medium, and system capable of extracting a variety of semantic concepts included in a photo based on content-based features of the photo and automatically classifying photos into a variety of categories.

Embodiments of the present invention further include at least a category-based clustering method, medium, and apparatus using region division templates by which photo data may be effectively divided into regions, with at least a semantic concept of each of the divided regions being extracted, and through efficient merging of local semantic concepts to find a global meaning of the photo, a semantic concept included in the photo may be categorized.

To achieve the above and/or other aspects and advantages, embodiments of the present invention include at least a clustering method of a digital photo album using region division templates, the method including dividing a photo into regions using region division templates, modeling a semantic concept included in a divided region, merging semantic concepts of respective divides regions with respect to a confidence degree of a local meaning measured from the modeling of the semantic concept included in the divided region, wherein the confidence degree is a measured value indicating a degree to which an image of the divided region includes the semantic concept corresponding to the divided region, modeling a global semantic concept included in the photo by using a final local semantic concept determined after the merging, and determining one or more categories included in the input photo according to a confidence degree of the global semantic concept measured from the modeling of the global semantic concept.

The region division templates for use in the modeling of the semantic concept may be expressed by the following equations:

$$\begin{matrix}T ( 1 ) = \{ \frac{w}{ 4} , \frac{h}{ 4} , \frac{3 w}{ 4} , \frac{3 h}{ 4} \} , \cdot T ( 2 ) = \{ 0 , 0 , \frac{w}{ 2} , \frac{h}{ 2} \} , \cdot \\ T ( 3 ) = \{ \frac{w}{ 2} , 0 , w , \frac{h}{ 2} \} , \cdot T ( 5 ) = \{ \frac{w}{ 2} , \frac{h}{ 2} , w , h \} , \cdot \\ T ( 6 ) = \{ 0 , 0 , w , \frac{h}{ 2} \} , T ( 7 ) = I \{ 0 , \frac{h}{ 2} , w , h \} , \cdot \\ T ( 8 ) = \{ 0 , 0 , \frac{w}{ 2} , h \} , \cdot T ( 9 ) = \{ \frac{w}{ 2} , 0 , w , h \} \\ T ( 10 ) = \{ 0 , 0 , w , h \} .\end{matrix}$$

Here, T is a template of a photo, w is a length of a width of the photo, and h is a length of a height of the photo.

In the modeling of the semantic concept, the semantic concept may be modeled by extracting content-based feature values of the photo. The content-based feature values may include color, texture, and shape information of an image.

In the modeling of the semantic concept the semantic concept may include an item (L_{entity}) indicating an entity of a semantic concept included in a photo and an item (L_{attribute}) indicating a the attribute of the entity of the semantic concept. The semantic concept modeling may be modeling of the entity concept and the attribute concept of the divided region.

In the modeling of the semantic concept, modeling of local concepts of the input photo, in which regions are divided, may be performed by using a support vector machine (SVM).

In the merging of the semantic concepts of respective divided regions, a respective confidence degree for each local semantic concept may be measured by using one SVM for each defined local semantic concept.

In the merging of the semantic concepts of respective divided regions, based on confidence degrees of local concepts allocated to 10, regions divided by using the region division templates, local concept confidence degrees of 5 basic regions may be merged according to the following equation:
C′_{L}(T(1))=max{C_{L}(T)|Tε{T(1),T(10)}}, [symbol]
C′_{L}(T(2))=max{C_{L}(T)|Tε{T(2),T(6),T(8),T(10)}},•
C′_{L}(T(3))=max{C_{L}(T)|Tε{T(3),T(6),T(9),T(10)}},•
C′_{L}(T(4))=max{C_{L}(T)|Tε{T(4),T(7),T(8),T(10)}},•
C′_{L}(T(5))=max{C_{L}(T)|Tε{T(5),T(7),T(9),T(10)}},•

Here, T(1), T(2), T(3), T(4), and T(5) indicate basic regions to which final local semantic concepts are allocated, and C_{L}′ is a confidence degree vector of a divided region. Here, a confidence degree C′_{local} of a local concept obtained after the merging may be expressed as the following expression:
C′_{local}={C′_{local}(T(1)),C′_{local}(T(2)),C′_{local}(T(3)),C′_{local}(T(4)),C′_{local}(T(5))}•

Here, C′_{local}(T) is a vector of a confidence degree set in relation to semantic concept L_{local} merged in a divided region T.

In the modeling of the global semantic concept the global concept of the photo, in which regions are divided, may be modeled by using an SVM. Here, by using a confidence degree of a local concept as an input, the confidence degree of a global concept may be measured.

In the determining of the categories, a global semantic concept having a highest confidence degree value among confidence degrees of the global semantic concepts measured from the modeled global semantic concept may be determined as a category of the photo.

In the determining of the categories, global semantic concepts having confidence degree values greater than a predetermined threshold value, among confidence degrees of the global semantic concepts, measured from the modeled global semantic concept, may be determined as categories of the photo.

To achieve the above and/or other aspects and advantages, embodiments of the present invention include at least a clustering apparatus of a digital photo album using region division templates, the apparatus including a region division unit to divide a photo into regions using region division templates, a local semantic concept modeling unit to model a semantic concept included in a divided region, a local semantic concept merging unit to merge semantic concepts of respective divided regions with respect to a confidence degree of a local meaning measured from the modeling of the semantic concept included in the divided region, wherein the confidence degree is a measured value indicating a degree to which the image of the divided region includes the semantic concept corresponding to the divided region, a global semantic concept modeling unit to model a global semantic concept included in the photo by using a final local semantic concept determined after the merging, and a category determination unit to determine one or more categories included in the input photo according to a confidence degree of the global semantic concept measured from the modeling of the global semantic concept modeling unit.

The apparatus may further include a photo input unit to receive an input of photo data for category-based clustering.

The local semantic concept modeling unit may models the semantic concept by extracting content-based feature values of the photo, with the content-based feature values including at least color, texture, and/or shape information of an image.

A local semantic concept may include an item (L_{entity}) indicating an entity of a semantic concept included in the photo and an item (L_{attribute}) indicating an attribute of the entity of the semantic concept.

Here, in the semantic concept modeling of the local semantic concept modeling unit, modeling of local concepts of the photo, in which regions are divided, may be performed by using a support vector machine (SVM).

In the measuring of the confidence degree by the local semantic concept merging unit, a confidence degree of each local semantic concept may be measured by using one SVM for each defined local semantic concept.

In the merging of the semantic concepts of the divided regions, based on confidence degrees of local concepts allocated to 10 regions, divided by using the region division templates, local concept confidence degrees of 5 basic regions may be merged according to the following equation:
C′_{L}(T(1))=max{C_{L}(T)|Tε{T(1),T(10)}}, [symbol]
C′_{L}(T(2))=max{C_{L}(T)|Tε{T(2),T(6),T(8),T(10)}},•
C′_{L}(T(3))=max{C_{L}(T)|Tε{T(3),T(6),T(9),T(10)}},•
C′_{L}(T(4))=max{C_{L}(T)|Tε{T(4),T(7),T(8),T(10)}},•
C′_{L}(T(5))=max{C_{L}(T)|Tε{T(5),T(7),T(9),T(10)}},•

Here, T(1), T(2), T(3), T(4), and T(5) indicate basic regions to which final local semantic concepts are allocated, and C_{L}′ is a confidence degree vector of a divided region.

Here, a confidence degree C′_{local} of a local concept obtained after the merging may be expressed as the following expression:
C′_{local}={C′_{local}(T(1)),C′_{local}(T(2)),C′_{local}(T(3)),C′_{local}(T(4)),C′_{local}(T(5))}•

Here, C′_{local}(T) is a vector of a confidence degree set in relation to semantic concept L_{local} merged in a divided region T.

The global semantic concept modeling unit may model the global concept of the photo, in which regions are divided, by using an SVM.

In the measuring of the confidence degree of a global concept by the category determination unit, by using a confidence degree of a local concept as an input, the confidence degree of the global concept may be measured.

The category determination unit determines a global semantic concept having a highest confidence degree value among confidence degrees of global semantic concepts measured from the modeled global semantic concept may be determined as a category of the photo.

The category determination unit determines global semantic concepts, having confidence degree values greater than a predetermined threshold value, among confidence degrees of the global semantic concepts measured from the modeled global semantic concept, may be determined as categories of the photo.

To achieve the above and/or other aspects and advantages, embodiments of the present invention include at least one medium including computer readable code to implement embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a photo clustering system using region division templates, according to an embodiment of the present invention;

FIG. 2 illustrates a photo clustering method using region division templates, according to an embodiment of the present invention;

FIG. 3 illustrates region division templates, according to an embodiment of the present invention;

FIG. 4 illustrates a dividing of a photo according to region division templates, according to another embodiment of the present invention;

FIG. 5 illustrates entity concepts and attribute concepts of a divided region, according to still another embodiment of the present invention;

FIG. 6 illustrates a local concept modeling, in greater detail, according to an embodiment of the present invention;

FIG. 7 illustrates a grouping of regions that are the objects of concept merging performed in a local semantic concept merging unit, according to an embodiment of the present invention; and

FIG. 8 illustrates a category-based clustering process of a digital photo album, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

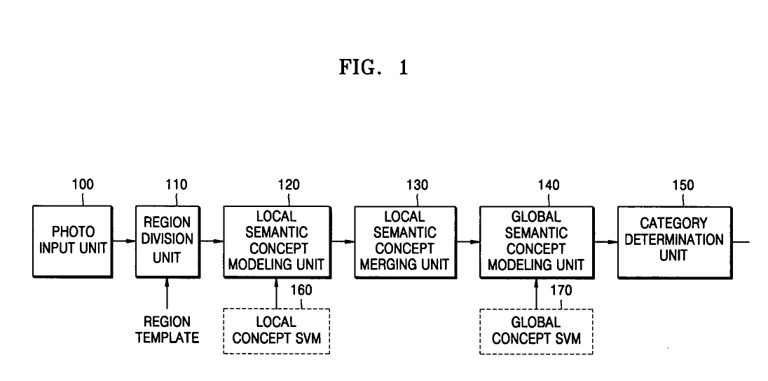

FIG. 1 illustrates a photo clustering system using region division templates, according to an embodiment of the present invention. The photo clustering system may include a region division unit 110, a local semantic concept modeling unit 120, a local semantic concept merging unit 130, a global semantic concept modeling unit 140, and a category determination unit 150, for example. The photo clustering system may further include a photo input unit 100, as another example.

According to an embodiment of the present invention, the photo input unit 100 may receive photo data for category-based clustering. For example, a photo stream may be input from an internal memory apparatus of a digital camera or a portable memory apparatus, noting that additional embodiments are equally available. The photo data may be based on ordinary still image data, for example, with the format of the photo data being an image data format such as joint photographic experts group (JPEG), TIFF and RAW formats, with the format of the photo data not being limited to these examples.

The region division unit 110 may divide a photo into regions by using region division templates, according to an embodiment of the present invention.

The local semantic concept modeling unit 120 may model at least a semantic concept, included in the divided region, and use a local concept support vector machine (SVM) 160, according to an embodiment of the present invention

When it is assumed that a measured value, e.g., a confidence degree, indicates the degree to which the image of the region includes a semantic concept, the local semantic concept merging unit 130 may merge the semantic concepts of respective regions with respect to the confidence degree of a local meaning measured from the modeling.

Thus, the global semantic concept modeling unit 140 may model a global semantic concept included in the photo by using the final local semantic concept determined through the merging, and use a global concept SVM 170.

The category determination unit 150 may identify one or more categories included in the input photo according to the confidence degree of the global semantic concept measured from the global semantic concept modeling.

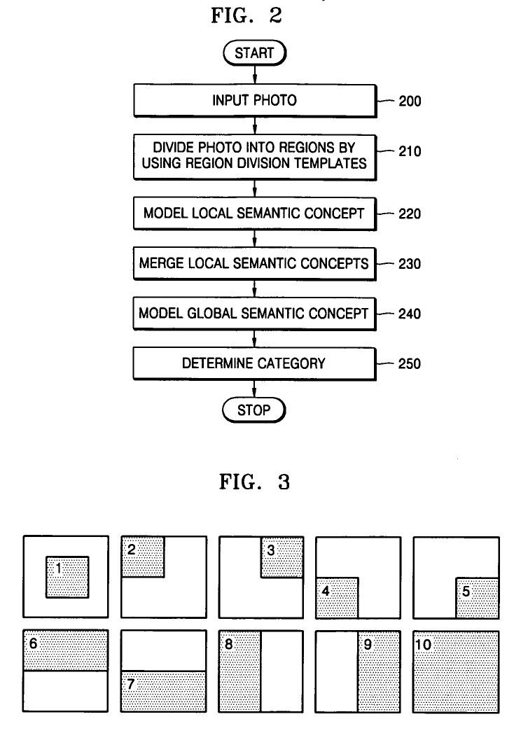

FIG. 2 illustrates a photo clustering method using region division templates, according to an embodiment of the present invention. Referring to FIGS. 1 and 2, a photo clustering method, using region division templates, and an operation of a system for such a method, according to embodiments of the present invention, will now be explained in greater detail.

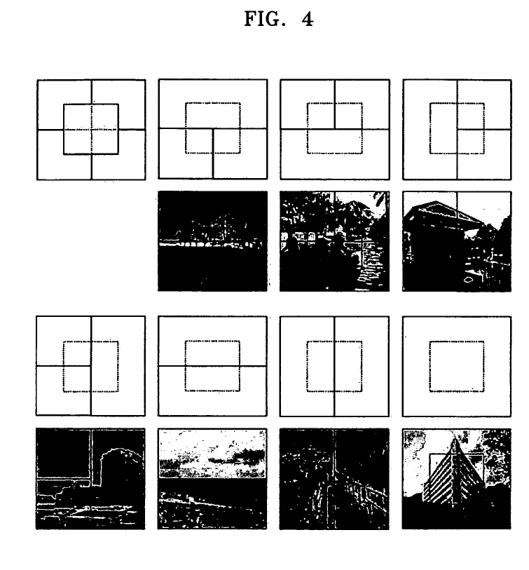

A photo stream from an internal memory apparatus of a digital camera, or a portable memory apparatus, for example, may be input, in operation 200. According to an embodiment of the present invention, the input photo may be divided by using region division templates, in operation 210, e.g., such as the region division templates of FIG. 3. An embodiment of the present invention may further include division of a photo with 10 base templates, for example, as shown in the embodiment of FIG. 3. Accordingly, in this case, the 10 region division base templates may be expressed according to the following Equation 1:
T={T(t)|tε10} (1)

Here, T(t) may correspond to a t-th region division template.

If the input photo I has dimensions of width w and length h, the coordinates of each of the region division templates may be expressed according to the following Equation 2:
T(t)={left(t),top(t),right(t),bottom(t)} (2)

Here, left(t) corresponds to the x coordinate of the left side of the t-th template, top(t) corresponds to the y coordinate of the top side of the t-th template, right (t) corresponds to the x coordinate of the right side of the t-th template, and bottom (t) corresponds to the y coordinate of the bottom side of the t-th template. According to Equation 2, coordinates of each of the templates may be expressed according to the following Equations 3:

$$\begin{matrix}T ( 1 ) = \{ \frac{w}{ 4} , \frac{h}{ 4} , \frac{3 w}{ 4} , \frac{3 h}{ 4} \} , \cdot T ( 2 ) = \{ 0 , 0 , \frac{w}{ 2} , \frac{h}{ 2} \} , \cdot \\ T ( 3 ) = \{ \frac{w}{ 2} , 0 , w , \frac{h}{ 2} \} , \cdot T ( 5 ) = \{ \frac{w}{ 2} , \frac{h}{ 2} , w , h \} , \cdot \\ T ( 6 ) = \{ 0 , 0 , w , \frac{h}{ 2} \} , T ( 7 ) = I \{ 0 , \frac{h}{ 2} , w , h \} , \cdot \\ T ( 8 ) = \{ 0 , 0 , \frac{w}{ 2} , h \} , \cdot T ( 9 ) = \{ \frac{w}{ 2} , 0 , w , h \} \\ T ( 10 ) = \{ 0 , 0 , w , h \} .\end{matrix} \qquad ( 3 )$$

The input photo I, divided according to such region division templates, may be expressed according to the following Equation 4:
I={I(T)|TεT} (4)

According to an embodiment of the present invention, FIG. 4 illustrates a dividing of a photo, e.g., as performed in the region division unit 110. As illustrated in FIG. 4, a local semantic concept may be included in each of the divided regions. For example, in the case of the first illustrated photo, the sky is included on the top, riverside is included on the bottom left corner, and a lawn is included on the bottom right corner. Here, such differing semantic concept information included in the photo is well expressed.

Multiple content-based features may be extracted from each of the divided regions and a local semantic concept may be modeled, in operation 220. The multiple content-based features may be expressed as the following Equation 5:
F={F(f)|fεN_{f}}• (5)

Here, N_{f} is the number of user feature values. According to an embodiment of the present invention, such a method of extracting content-based feature values may extract content based features using color, texture, and shape information, for example, of an image as basic features, and basically may include a method of extracting feature values by using an MPEG-7 descriptor, for example. However, alternative methods of extracting the content-based feature values are not limited to the MPEG-7 descriptor.

The multiple content-based feature values, extracted from a region divided by template T, may be expressed according to the following Equation 6:
F_{T}={F_{T}(f)|fεN_{f}} (6)

Based on the given region-based feature values, a local semantic concept included in each of the divided regions may be modeled.

For this, local semantic concepts, which may be included in a target category of category-based clustering, may be defined.

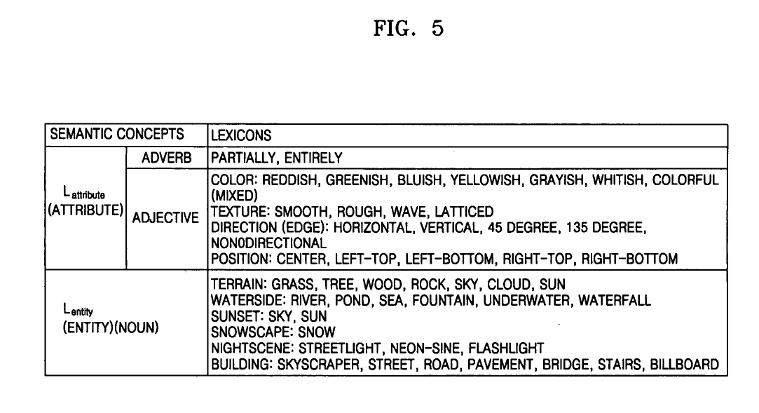

According to an embodiment of the present invention, a local semantic concept, L_{local}, may be made up of L_{entity}, which may be an item indicating the entity of a semantic concept being included in a photo, and L_{attribute}, which may be an item indicating an attribute of the entity of a semantic concept. FIG. 5 illustrates a table showing a local concept with the entity concept of a divided region and an attribute concept expressing the attribute of the entity concept. according to an embodiment of the present invention.

Again, L_{entity} may be an item indicating the entity of a semantic concept, and may be expressed according to the following Equation 7:
L_{entity}={L_{entity}(e)|eεNₑ} (7)

Here, L_{entity} may be an e-th entity semantic concept, and N, may be the number of defined entity semantic concepts.

Similarly, L_{attribute} may be an item indicating the attribute of a semantic concept, and may be expressed according to the following Equation 8:
L_{attribute}={L_{attribute}(a)|aεNₐ} (8)

Here, L_{attibbute}(a) may be an a-th attribute semantic concept, and Nₐ may be the number of defined attribute semantic concepts.

The local semantic concept L_{local} may be expressed according to the following Equation 9:
L_{local}={L_{entity},L_{attribute}}={L(l)|lε(Nₑ+Nₐ)} (9)

Here, L(l) may be an l-th semantic concept, and can be an entity semantic concept or an attribute semantic concept, for example.

Based on the local semantic concepts, as described above, a training sample image having respective local semantic concepts may be collected, and the content-based feature values may be extracted from the collected images and

The extracted feature values may be trained by using a support vector machine (SVM), for example. SVMlocal, trained in relation to each of the local semantic concepts, may be expressed according to the following Equation 10:
SVM_{local}={SVM_{L}(F)|LεL_{local}} (10)

Here, SVM_{L} is an SVM trained for semantic concept L. As the input of the SVMlocal, the content-based feature value vector F described above may be input.

Next, by using the trained SVMlocal, a local concept of the input photo I, in which regions are divided, may be modeled. That is, the input photo I may be divided into regions according to a method described above and the divided region images may be modeled by using the trained SVMlocal, for example. The modeling of the local concept may include a process of inputting the content-based feature values extracted from the divided region images, into the SVML of semantic concept L and an extracting of the confidence degree of the semantic concept.

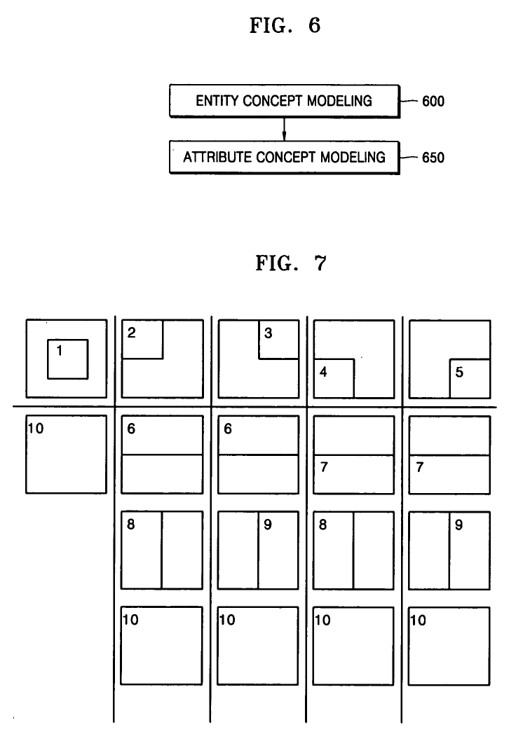

FIG. 6 illustrates a local concept modeling, such as that of the operation 220, in greater detail, according to an embodiment of the present invention. That is, the local concept modeling may include a local entity concept modeling, in operation 600, and a local attribute concept modeling, in operation 650.

The confidence degree of a semantic concept, in relation to divided region T, may be obtained according to the following Equation 11:
C_{L}(T)=SVM_{L}(F_{T}) (11)

Here, F_{T} is a content-based feature value vector of divided region T, and C_{L}(T) may be the confidence degree of semantic concept L of the divided region T. The confidence degree may be a measured value on how much of a divided region image includes a semantic concept corresponding to the region.

A confidence degree vector, obtained by performing SVMs of all defined local semantic concepts, may be expressed according to the following Equation 12:
C_{local}(T)={C_{L}(T)=SVM_{L}(F_{T})|LεL_{local}}

Here, C_{local}(T) may be a confidence degree vector of each of all local semantic concepts modeled in relation to divided region T.

As a result, the confidence degree of the local semantic concept, e.g., in relation to 10 divided regions, can be obtained and a confidence degree vector of the local semantic concept, e.g., again obtained in relation to the 10 divided regions, may be expressed according to the following Equation 13:
C_{local}={C_{local}(T)|TεT}={C_{local}(T(1)),C_{local}(T(2)),C_{local}(T(3)),C_{local}(T(10))} (13)

The defined division regions may include regions spatially overlapping each other. That is, divided region T(1) may overlap T(10), T(2) may overlap T(6), T(8), and T(10), T(3) may overlap T(6), T(9), and T(10), T(4) may overlap T(7), T(8), and T(10), and T(5) may overlap T(7), T(9), and T(10), for example. Accordingly, a total of five overlapping region groups may exist. In an embodiment of the present invention, in order to extract a more reliable local semantic concept, a process of merging the confidence degrees of the local concepts of the overlapping region groups may be included in operation 230.

According to an embodiment of the present invention, as a method of merging semantic concepts of overlapping region groups, there may also be included: a method by which divided regions T(1) and T(10) may be merged into T(1); T(2), T(6), T(8), and T(10) may be merged into T(2); T(3), T(6), T(9), and T(10) may be merged into T(3); T(4), T(7), T(8), and T(10) may be merged into T(4); and T(5), T(7), T(9), and T(10) may be merged into T(5). The local semantic concept merging process may include a process of allocating a highest confidence degree value, among semantic concepts allocated to divided regions belonging to each divided region group, to a corresponding merging region.

FIG. 7 illustrates a grouping of regions that are the objects of local concept merging, e.g., performed in the local semantic concept merging unit 130, according to an embodiment of the present invention. The local semantic concept merging process may be expressed according to the following Equation 14:
C′_{L}(T(1))=max{C_{L}(T)|Tε{T(1),T(10)}}, [symbol]
C′_{L}(T(2))=max{C_{L}(T)|Tε{T(2),T(6),T(8),T(10)}},•
C′_{L}(T(3))=max{C_{L}(T)|Tε{T(3),T(6),T(9),T(10)}},•
C′_{L}(T(4))=max{C_{L}(T)|Tε{T(4),T(7),T(8),T(10)}},•
C′_{L}(T(5))=max{C_{L}(T)|Tε{T(5),T(7),T(9),T(10)}},• (14)

As a result, T(1), T(2), T(3), T(4), and T(5) may be determined as final divided regions, for example, and the confidence degree C_{local} of the local semantic concept, allocated to each divided region, may be expressed according to the following Equation 15:
C′_{local}={C′_{local}(T(1)),C′_{local}(T(2)),C′_{local}(T(3)),C′_{local}(T(4)),C′_{local}(T(5))}• (15)

Here, each C′_{local}(T) may be the vector of a confidence degree set in relation to semantic concept L_{local} determined in divided region T.

Based on the confidence degree of the local semantic concept, measured as described above, a global semantic concept, that is, a category concept, included in the input photo I may be modeled, in operation 240.

For this, sample images of photos belonging to each category may be collected, and from the collected sample images, the confidence degree C′_{local} of a local semantic concept may be obtained through the same process, for example, as described above. Based on this confidence degree, a process of training using an SVM may be performed, according to an embodiment of the present invention. A global semantic concept, that is, a category concept, may be expressed according the following Equation 16:
L_{global}={L(g)|gεN_{g}}• (16)

Here, L(g) may be a g-th category concept and Ng may be the number of category concepts.

SVMglobal, trained in relation to each category concept, may be expressed according to the following Equation 17:
SVM_{global}={SVM_{G}(C_{local})|GεL_{global}}• (17)

Here, SVM_{G} may be the SVM trained for category concept G. As the input of SVM_{global}, C_{local}, which is the confidence degree set of semantic concepts extracted from the divided regions and merged, may be used.

By using the trained SVM_{global}, the category concept of the input photo I may be modeled, in operation 240. C_{local}, which is the confidence degree set of local semantic concepts of the input photo, is input to an SVM for modeling each category concept, and the confidence degree of each category concept in relation to the input photo I may be obtained. The confidence degree of the modeled category concept G may be expressed according to the following Equation 18:
C_{G}=SVM_{G}(C_{local}) (18)

Here, C_{G} is the confidence degree of category concept G. The confidence degree set C_{global}, of the global category concept obtained based on a method described above, may be expressed according to the following Equation 19:
C_{global}={C_{G}|GεL_{global}} (19)

The final category concept of the input photo I may be determined by selecting a category having the highest confidence degree among the defined confidence degrees of the category concept L_{global}. An embodiment of the present invention may include a method of selecting a category concept having a highest confidence degree, and a method of selecting a category concept having a confidence degree equal to or greater than a predetermined value, for example.

A method of selecting a category concept having a highest confidence degree may be expressed according to the following Equation 20:

$${L}_{target} = {argmax}_{G ∈ {L}_{global}} \{ {C}_{G} \} . \qquad ( 20 )$$

Here, L_{target} is a category concept finally selected.

The method of selecting a category concept having a confidence degree equal to or greater than a predetermined value may be expressed according to the following Equation 21:

$${L}_{target} = {arg}_{G ∈ {L}_{global}} \{ {C}_{G} > {C}_{th} \} \qquad ( 21 )$$

Here, Cₜₕ is a threshold value of a confidence value to select a final category concept.

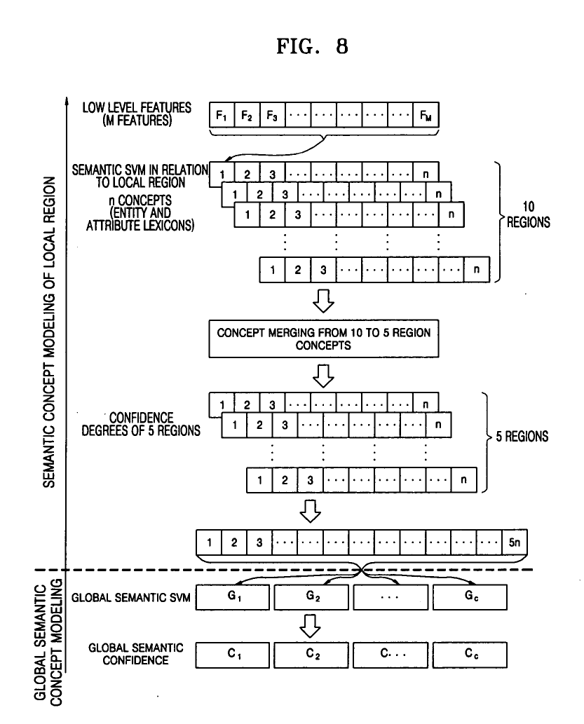

FIG. 8 illustrates a category-based clustering process, e.g., of a digital photo album, according to an embodiment of the present invention.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The set forth embodiments should be considered in descriptive sense only and not for purposes of limitation. Therefore, the scope of the invention is defined not by the detailed description of the invention but by the appended claims, and all differences within the scope will be construed as being included in the present invention.

Thus, according to a category-based clustering method, medium, and apparatus for a digital photo album, according to an embodiment of the present invention, by using together user preference and content-based feature value information, for example, such as color, texture, and shape, from contents of photos, as well as information that can be basically obtained from photos, such as camera information and file information stored in a camera, a large volume of photos may be effectively categorized such that an album can be fast and effectively generated with photo data.

Accordingly, again, a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A clustering method of a digital photo album using region division templates, the method comprising:
dividing a photo into regions using region division templates;
modeling a semantic concept included in a divided region;
merging semantic concepts of respective divides regions with respect to a confidence degree of a local meaning measured from the modeling of the semantic concept included in the divided region, wherein the confidence degree is a measured value indicating a degree to which an image of the divided region includes the semantic concept corresponding to the divided region;
modeling a global semantic concept included in the photo by using a final local semantic concept determined after the merging; and
determining one or more categories included in the input photo according to a confidence degree of the global semantic concept measured from the modeling of the global semantic concept.

2. The method of claim 1, wherein the region division templates for use in the modeling of the semantic concept are expressed by the following equations:
$$\begin{matrix}T ( 1 ) = \{ \frac{w}{ 4} , \frac{h}{ 4} , \frac{3 w}{ 4} , \frac{3 h}{ 4} \} , \cdot T ( 2 ) = \{ 0 , 0 , \frac{w}{ 2} , \frac{h}{ 2} \} , \cdot \\ T ( 3 ) = \{ \frac{w}{ 2} , 0 , w , \frac{h}{ 2} \} , \cdot T ( 5 ) = \{ \frac{w}{ 2} , \frac{h}{ 2} , w , h \} , \cdot \\ T ( 6 ) = \{ 0 , 0 , w , \frac{h}{ 2} \} , T ( 7 ) = I \{ 0 , \frac{h}{ 2} , w , h \} , \cdot \\ T ( 8 ) = \{ 0 , 0 , \frac{w}{ 2} , h \} , \cdot T ( 9 ) = \{ \frac{w}{ 2} , 0 , w , h \} \\ T ( 10 ) = \{ 0 , 0 , w , h \} ,\end{matrix}$$
where T is a template of a photo, w is a length of a width of the photo, and h is a length of a height of the photo.

3. The method of claim 1, wherein in the modeling of the semantic concept, the semantic concept is modeled by extracting content-based feature values of the photo.

4. The method of claim 3, wherein the content-based feature values comprise color, texture, and shape information of an image.

5. The method of claim 1, wherein in the modeling of the semantic concept the semantic concept includes an item (L_{entity}) indicating an entity of a semantic concept included in a photo and an item (L_{attribute}) indicating a the attribute of the entity of the semantic concept.

6. The method of claim 5, wherein the semantic concept modeling is modeling of the entity concept and the attribute concept of the divided region.

7. The method of claim 1, wherein in the modeling of the semantic concept, modeling of local concepts of the input photo, in which regions are divided, is performed by using a support vector machine (SVM).

8. The method of claim 7, wherein in the merging of the semantic concepts of respective divided regions, a respective confidence degree for each local semantic concept is measured by using one SVM for each defined local semantic concept.

9. The method of claim 2, wherein in the merging of the semantic concepts of respective divided regions, based on confidence degrees of local concepts allocated to 10, regions divided by using the region division templates, local concept confidence degrees of 5 basic regions are merged according to the following equation:
C′_{L}(T(1))=max{C_{L}(T)|Tε{T(1),T(10)}}, [symbol]
C′_{L}(T(2))=max{C_{L}(T)|Tε{T(2),T(6),T(8),T(10)}},•
C′_{L}(T(3))=max{C_{L}(T)|Tε{T(3),T(6),T(9),T(10)}},•
C′_{L}(T(4))=max{C_{L}(T)|Tε{T(4),T(7),T(8),T(10)}},•
C′_{L}(T(5))=max{C_{L}(T)|Tε{T(5),T(7),T(9),T(10)}},•
where T(1), T(2), T(3), T(4), and T(5) indicate basic regions to which final local semantic concepts are allocated, and C_{L}′ is a confidence degree vector of a divided region.

10. The method of claim 9, wherein a confidence degree C′_{local} of a local concept obtained after the merging is expressed as the following expression:
C′_{local}={C′_{local}(T(1)),C′_{local}(T(2)),C′_{local}(T(3)),C′_{local}(T(4)),C′_{local}(T(5))}•
where, C′_{local}(T) is a vector of a confidence degree set in relation to semantic concept L_{local} merged in a divided region T.

11. The method of claim 1, wherein in the modeling of the global semantic concept the global concept of the photo, in which regions are divided, is modeled by using an SVM.

12. The method of claim 11, wherein by using a confidence degree of a local concept as an input, the confidence degree of a global concept is measured.

13. The method of claim 1, wherein in the determining of the categories, a global semantic concept having a highest confidence degree value among confidence degrees of the global semantic concepts measured from the modeled global semantic concept is determined as a category of the photo.

14. The method of claim 1, wherein in the determining of the categories, global semantic concepts having confidence degree values greater than a predetermined threshold value, among confidence degrees of the global semantic concepts, measured from the modeled global semantic concept, are determined as categories of the photo.

15. A clustering apparatus of a digital photo album using region division templates, the apparatus comprising:
a region division unit to divide a photo into regions using region division templates;
a local semantic concept modeling unit to model a semantic concept included in a divided region;
a local semantic concept merging unit to merge semantic concepts of respective divided regions with respect to a confidence degree of a local meaning measured from the modeling of the semantic concept included in the divided region, wherein the confidence degree is a measured value indicating a degree to which the image of the divided region includes the semantic concept corresponding to the divided region;
a global semantic concept modeling unit to model a global semantic concept included in the photo by using a final local semantic concept determined after the merging; and
a category determination unit to determine one or more categories included in the input photo according to a confidence degree of the global semantic concept measured from the modeling of the global semantic concept modeling unit.

16. The apparatus of claim 15, further comprising a photo input unit to receive an input of photo data for category-based clustering.

17. The apparatus of claim 15, wherein the local semantic concept modeling unit models the semantic concept by extracting content-based feature values of the photo, with the content-based feature values comprising at least color, texture, and/or shape information of an image.

18. The apparatus of claim 17, wherein a local semantic concept includes an item (L_{entity}) indicating an entity of a semantic concept included in the photo and an item (L_{attribute}) indicating an attribute of the entity of the semantic concept.

19. The apparatus of claim 18, wherein in the semantic concept modeling of the local semantic concept modeling unit, modeling of local concepts of the photo, in which regions are divided, is performed by using a support vector machine (SVM).

20. The apparatus of claim 19, wherein in the measuring of the confidence degree by the local semantic concept merging unit, a confidence degree of each local semantic concept is measured by using one SVM for each defined local semantic concept.

21. The apparatus of claim 15, wherein in the merging of the semantic concepts of the divided regions, based on confidence degrees of local concepts allocated to 10 regions, divided by using the region division templates, local concept confidence degrees of 5 basic regions are merged according to the following equation:
C′_{L}(T(1))=max{C_{L}(T)|Tε{T(1),T(10)}}, [symbol]
C′_{L}(T(2))=max{C_{L}(T)|Tε{T(2),T(6),T(8),T(10)}},•
C′_{L}(T(3))=max{C_{L}(T)|Tε{T(3),T(6),T(9),T(10)}},•
C′_{L}(T(4))=max{C_{L}(T)|Tε{T(4),T(7),T(8),T(10)}},•
C′_{L}(T(5))=max{C_{L}(T)|Tε{T(5),T(7),T(9),T(10)}},•
where T(1), T(2), T(3), T(4), and T(5) indicate basic regions to which final local semantic concepts are allocated, and C_{L}′ is a confidence degree vector of a divided region.

22. The apparatus of claim 21, wherein a confidence degree C′_{local} of a local concept obtained after the merging is expressed as the following expression:
C′_{local}={C′_{local}(T(1)),C′_{local}(T(2)),C′_{local}(T(3)),C′_{local}(T(4)),C′_{local}(T(5))}•
where, C′_{local}(T) is a vector of a confidence degree set in relation to semantic concept L_{local} merged in a divided region T.

23. The apparatus of claim 15, wherein the global semantic concept modeling unit models the global concept of the photo, in which regions are divided, by using an SVM.

24. The apparatus of claim 23, wherein in measuring of the confidence degree of a global concept by the category determination unit, by using a confidence degree of a local concept as an input, the confidence degree of the global concept is measured.

25. The apparatus of claim 15, wherein the category determination unit determines a global semantic concept having a highest confidence degree value among confidence degrees of global semantic concepts measured from the modeled global semantic concept is determined as a category of the photo.

26. The apparatus of claim 15, wherein the category determination unit determines global semantic concepts, having confidence degree values greater than a predetermined threshold value, among confidence degrees of the global semantic concepts measured from the modeled global semantic concept, are determined as categories of the photo.

27. At least one medium comprising computer readable code to implement the method of claim 1.
